(19) United States
(12) Patent Application Publication
(10) Pub. No.: US 2024/0314228 A1
(43) Pub. Date: Sep. 19, 2024

(54) SYSTEM AND METHOD FOR FRAME PROTECTION

(71) Applicant: NXP USA, Inc., Austin, TX (US)

(72) Inventors: Liwen Chu, San Ramon, CA (US); Huizhao Wang, San Jose, CA (US); Kiseon Ryu, San Diego, CA (US); Hongyuan Zhang, Fremont, CA (US)

(21) Appl. No.: 18/605,532

(22) Filed: Mar. 14, 2024

Related U.S. Application Data
(60) Provisional application No. 63/490,030, filed on Mar. 14, 2023.
(60) Provisional application No. 63/558,180, filed on Feb. 27, 2024.

(51) Int. Cl. H04L 69/22; H04L 9/06

(52) U.S. Cl. CPC H04L 69/22; H04L 9/0637

(57) ABSTRACT

Embodiments of a method and apparatus for communications are disclosed. In an embodiment, a communications device includes a controller configured to generate a frame including a Media Access Control (MAC) header and a security encapsulation for MAC header protection and a transceiver configured to transmit the frame to a second communications device. The security encapsulation includes packet number (PN) information, key identification (ID) information, and message integrity check (MIC) information.

### CROSS-REFERENCE TO RELATED APPLICATIONS

This application is entitled to the benefit of U.S. Provisional Patent Application Ser. No. 63/490,030, filed on Mar. 14, 2023 and U.S. Provisional Patent Application Ser. No. 63/558,180, filed on Feb. 27, 2024, the contents of each of which are incorporated by reference herein.

### BACKGROUND

In multi-link communications, an access point (AP) multi-link device (MLD) can transmit various types of information using different transmission techniques to a non-AP MLD. For example, a wireless AP MLD may wirelessly transmit data to one or more wireless stations in a non-AP MLD through one or more wireless communications links. To facilitate the proper data transmission within a multi-link communications system, there is a need for multi-link communications technology that can efficiently and securely convey communications signaling information, for example, information related to data, communications links, and/or multi-link devices (e.g., operation and/or capability parameters of multi-link devices) within the multi-link communications system.

### SUMMARY

Embodiments of a method and apparatus for communications are disclosed. In an embodiment, a communications device includes a controller configured to generate a frame (e.g., a unicast Data/Management frame) including a Media Access Control (MAC) header and a security encapsulation for MAC header protection and a transceiver configured to transmit the frame to a second communications device. The security encapsulation includes packet number (PN) information, key identification (ID) information, and message integrity check (MIC) information, for example, to protect the MAC header of the frame (e.g., a unicast Data/Management frame). Other embodiments are also disclosed.

In an embodiment, the frame is one of a unicast data frame and a unicast management frame.

In an embodiment, the communications device includes a wireless MLD, the second communications device includes a second wireless MLD, and the transceiver includes a wireless transceiver configured to transmit the frame to the second wireless MLD through a wireless link between the wireless MLD and the second wireless MLD.

In an embodiment, the controller is further configured to generate the frame including the MAC header, the security encapsulation for MAC header protection, a frame body, and a frame check sequence (FCS) field.

In an embodiment, the frame is included in an Aggregate MAC Protocol Data Unit (A-MPDU) subframe with a MAC Protocol Data Unit (MPDU) delimiter.

In an embodiment, the MPDU delimiter indicates whether the frame has security encapsulation for header protection or not.

In an embodiment, the security encapsulation is located after a Galois/Counter Mode Protection (GCMP) header of the frame.

In an embodiment, the security encapsulation is located right after the MAC header.

In an embodiment, a transmitter address (TA) of the frame is used to configure a Nonce for calculating the MIC information.

In an embodiment, the MAC header includes a redefined reserved bit for indicating that the security encapsulation is carried in the frame.

In an embodiment, a header-protection transient pairwise key (HTPK) is negotiated for all setup links between the communications device and the second communications device.

In an embodiment, separate PN spaces are used for different setup links between the communications device and the second communications device.

In an embodiment, the HPTK is used as the pairwise transient key for controlling frame protection.

In an embodiment, a wireless MLD includes a controller configured to generate a frame including a MAC header and a security encapsulation for MAC header protection, where the security encapsulation includes PN information, key ID information, and MIC information, and a wireless transceiver configured to transmit the frame to a second wireless MLD through a wireless link between the wireless MLD and the second wireless MLD, where the wireless MLD and the second wireless MLD are compatible with an Institute of Electrical and Electronics Engineers (IEEE) 802.11 protocol.

In an embodiment, the wireless MLD includes a wireless access point (AP) MLD or a non-AP station (STA) MLD.

In an embodiment, a method for communications involves at a first communications device, generating a frame including a MAC header and a security encapsulation for MAC header protection, where the security encapsulation includes PN information, key ID information, and MIC information, and from the first communications device, transmitting the frame to a second communications device.

In an embodiment, the frame is one of a unicast data frame and a unicast management frame.

In an embodiment, the first communications device includes a first wireless MLD, and the second communications device includes a second wireless MLD.

In an embodiment, the security encapsulation is located after a GCMP header of the frame.

In an embodiment, the first communications device or the second communications device is compatible with an IEEE 802.11 protocol.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts a multi-link communications system in accordance with an embodiment of the invention.

FIG. 2 depicts an example of an Aggregate MAC Protocol Data Unit (A-MPDU) subframe format.

FIG. 3 depicts a MAC Protocol Data Unit (MPDU) delimiter format in accordance with an embodiment of the invention.

FIG. 4 depicts a frame format in accordance with an embodiment of the invention.

FIG. 5 depicts a frame segment format in accordance with an embodiment of the invention.

FIG. 6 depicts a sequence control field format in accordance with an embodiment of the invention.

FIG. 7 depicts a frame format in accordance with an embodiment of the invention.

FIG. 8 depicts a frame format in accordance with an embodiment of the invention.

FIG. 9 depicts an Ultra High Reliability (UHR) physical layer protocol data unit (PPDU) in accordance with an embodiment of the invention.

FIG. 10 depicts a Header message integrity check (MIC) Information element (HME) format in accordance with an embodiment of the invention.

FIG. 11 depicts a Management MIC element (MME) format in accordance with an embodiment of the invention.

FIG. 12 depicts a wireless device in accordance with an embodiment of the invention.

FIG. 13 is a process flow diagram of a method for communications in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

In embodiments of a wireless communications system, a wireless device, e.g., an access point (AP) multi-link device (MLD) of a wireless local area network (WLAN) may transmit data to at least one associated station (STA) MLD. The AP MLD may be configured to operate with associated STA MLDs according to a communication protocol. For example, the communication protocol may be an Institute of Electrical and Electronics Engineer (IEEE) 802.11 communication protocol.

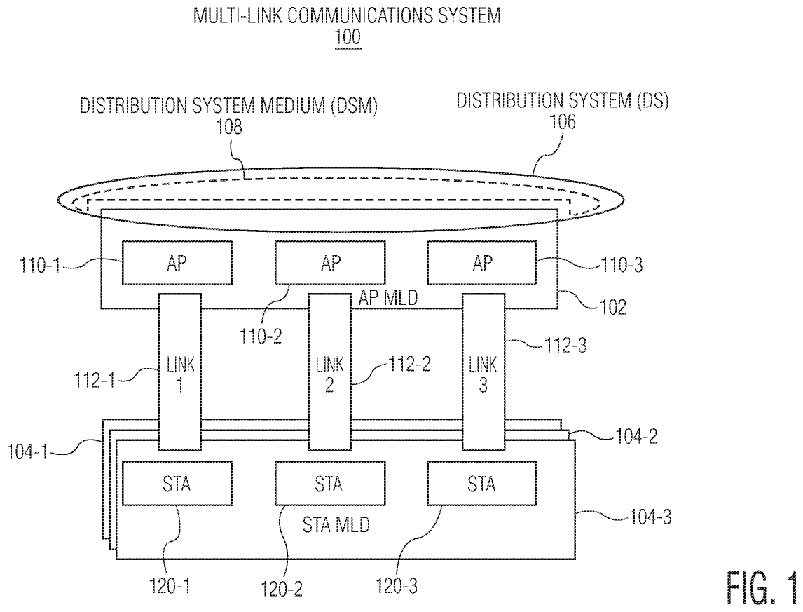

FIG. 1 depicts a multi-link (ML) communications system 100 in accordance with an embodiment of the invention. In the embodiment depicted in FIG. 1, the multi-link communications system includes at least one AP multi-link device (MLD) 102, and one or more non-AP multi-link devices, which are, for example, implemented as station (STA) MLDs 104-1, 104-2, 104-3. The multi-link communications system can be used in various applications, such as industrial applications, medical applications, computer applications, and/or consumer or appliance applications. In some embodiments, the multi-link communications system is a wireless communications system, such as a wireless communications system compatible with an Institute of Electrical and Electronics Engineers (IEEE) 802.11 protocol. Although the depicted multi-link communications system 100 is shown in FIG. 1 with certain components and described with certain functionality herein, other embodiments of the multi-link communications system 100 may include fewer or more components to implement the same, less, or more functionality. For example, although the multi-link communications system 100 is shown in FIG. 1 includes the AP MLD 102 and the STA MLDs 104-1, 104-2, 104-3, in other embodiments, the multi-link communications system includes other multi-link devices, such as, multiple AP MLDs and multiple STA MLDs, multiple AP MLDs and a single STA MLD, a single AP MLD and a single STA MLD. In another example, in some embodiments, the multi-link communications system includes more than three STA MLDs and/or less than three STA MLDs. In yet another example, although the multi-link communications system 100 is shown in FIG. 1 as being connected in a certain topology, the network topology of the multi-link communications system 100 is not limited to the topology shown in FIG. 1.

In the embodiment depicted in FIG. 1, the AP MLD 102 includes multiple radios, implemented as APs 110-1, 110-2, 110-3. In some embodiments, the AP MLD 102 is an AP multi-link logical device or an AP multi-link logical entity (MLLE). In some embodiments, a common part of the AP MLD 102 implements upper layer Media Access Control (MAC) functionalities (e.g., beaconing, association establishment, reordering of frames, etc.) and a link specific part of the AP MLD 102, i.e., the APs 110-1, 110-2, 110-3, implement lower layer MAC functionalities (e.g., backoff, frame transmission, frame reception, etc.). The APs 110-1, 110-2, 110-3 may be implemented in hardware (e.g., circuits), software, firmware, or a combination thereof. At least one of the APs 110-1, 110-2, 110-3 may be fully or partially implemented as an integrated circuit (IC) device. In some embodiments, the AP MLD and its affiliated APs 110-1, 110-2, 110-3 are compatible with at least one wireless local area network (WLAN) communications protocol (e.g., at least one IEEE 802.11 protocol, such as, an IEEE 802.11bn protocol). For example, the APs 110-1, 110-2, 110-3 may be wireless APs compatible with at least one WLAN communications protocol (e.g., at least one IEEE 802.11 protocol, such as, an IEEE 802.11bn protocol).

In some embodiments, an AP MLD (e.g., the AP MLD 102) is connected to a local network (e.g., a local area network (LAN)) and/or to a backbone network (e.g., the Internet) through a wired connection and wirelessly connects to wireless STAs, for example, through one or more WLAN communications protocols, such as an IEEE 802.11 protocol (e.g., an IEEE 802.11bn protocol). In some embodiments, an AP (e.g., the AP 110-1, the AP 110-2, and/or the AP 110-3) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 110-1, 110-2, 110-3 of the AP MLD 104 operates in different frequency bands. For example, at least one of the APs 110-1, 110-2, 110-3 of the AP MLD 104 operates in a 2.4/5/6 Gigahertz (GHz) frequency band. For example, the AP 110-1 may operate at 6 Gigahertz (GHz) band (e.g., in a 320 MHz (one million hertz) Basic Service Set (BSS) operating channel or other suitable BSS operating channel), the AP 110-2 may operate at 5 GHz band (e.g., a 160 MHz BSS operating channel or other suitable BSS operating channel), and the AP 110-3 may operate at 2.4 GHz band (e.g., a 20 MHz BSS operating channel or other suitable BSS operating channel). In the embodiment depicted in FIG. 1, the AP MLD is connected to a distribution system (DS) 106 through a distribution system medium (DSM) 108. The distribution system (DS) 106 may be a wired network or a wireless network that is connected to a backbone network such as the Internet. The DSM 108 may be a wired medium (e.g., Ethernet cables, telephone network cables, or fiber optic cables) or a wireless medium (e.g., infrared, broadcast radio, cellular radio, or microwaves). Although the AP MLD 102 is shown in FIG. 1 as including three APs, other embodiments of the AP MLD 102 may include fewer than three APs or more than three APs. In addition, although some examples of the DSM 108 are described, the DSM 108 is not limited to the examples described herein.

In the embodiment depicted in FIG. 1, the STA MLD 104-1 includes radios, which are implemented as multiple non-AP stations (STAs) 120-1, 120-2, 120-3. The STAs 120-1, 120-2, 120-3 may be implemented in hardware (e.g., circuits), software, firmware, or a combination thereof. At least one of the STAs 120-1, 120-2, 120-3 may be fully or partially implemented as an IC device. In some embodiments, the non-AP STAs 120-1, 120-2, 120-3 are part of the STA MLD 104-1, such that the STA MLD may be a communications device that wirelessly connects to a wireless AP MLD, such as, the AP MLD 102. For example, the STA MLD 104-1 (e.g., at least one of the non-AP STAs 120-1, 120-2, 120-3) may be implemented in a laptop, a desktop personal computer (PC), a mobile phone, or other communications device that supports at least one WLAN communications protocol. In some embodiments, the STA MLD and its affiliated STAs 120-1, 120-2, 120-3 are compatible with at least one IEEE 802.11 protocol (e.g., an IEEE 802.11bn protocol). In some embodiments, each of the non-AP STAs 120-1, 120-2, 120-3 includes at least one antenna, at least one transceiver operably connected to the at least one antenna, and at least one controller connected to the corresponding transceiver. In some embodiments, the at least one transceiver includes a PHY device. The at least one controller operably may be configured to control the at least one transceiver to process received packets through the at least one antenna. In some embodiments, the at least one controller is implemented within a processor, such as a microcontroller, a host processor, a host, a DSP, or a CPU, which can be integrated in a corresponding transceiver. In some embodiments, the STA MLD has one MAC data service interface. In an embodiment, a single address is associated with the MAC data service interface and is used to communicate on the DSM 108. In some embodiments, the STA MLD 104-1 implements a common MAC data service interface and the non-AP STAs 120-1, 120-2, 120-3 implement a lower layer MAC data service interface. In some embodiments, the AP MLD 102 and/or the STA MLDs 104-1, 104-2, 104-3 identify which communications links support the multi-link operation during a multi-link operation setup phase and/or exchanges information regarding multi-link capabilities during the multi-link operation setup phase. Each of the STAs 120-1, 120-2, 120-3 of the STA MLD may operate in a different frequency band. For example, at least one of the STAs 120-1, 120-2, 120-3 of the STA MLD 104-1 operates in the 2.4/5/6 GHz frequency band. For example, the STA 120-1 may operate at 6 GHz band (e.g., in a 320 MHz (one million hertz) BSS operating channel or other suitable BSS operating channel), the STA 120-2 may operate at 5 GHz band (e.g., a 160 MHz BSS operating channel or other suitable BSS operating channel), and the STA 120-3 may operate at 2.4 GHz band (e.g., a 20 MHz BSS operating channel or other suitable BSS operating channel). Although the STA MLD 104-1 is shown in FIG. 1 as including three non-AP STAs, other embodiments of the STA MLD 104-1 may include fewer than three non-AP STAs or more than three non-AP STAs.

Each of the MLDs 104-2, 104-3 may be the same as or similar to the MLD 104-1. For example, the MLD 104-2 or 104-3 includes multiple non-AP STAs. In some embodiments, each of the non-AP STAs includes at least one antenna, at least one transceiver operably connected to the at least one antenna, and at least one controller connected to the corresponding transceiver. In some embodiments, the at least one transceiver includes a PHY device. The at least one controller operably may be configured to control the at least one transceiver to process received packets through the at least one antenna. In some embodiments, the at least one controller is implemented within a processor, such as a microcontroller, a host processor, a host, a DSP, or a CPU, which can be integrated in a corresponding transceiver.

In the embodiment depicted in FIG. 1, the STA MLD 104-1 communicates with the AP MLD 102 through multiple communications links 112-1, 112-2, 112-3. For example, each of the STAs 120-1, 120-2, 120-3 communicates with an AP 110-1, 110-2, or 110-3 through a corresponding wireless communications link 112-1, 112-2, or 112-3. Although the AP MLD 102 communicates (e.g., wirelessly communicates) with the STA MLD 104-1 through multiple links 112-1, 112-2, 112-3, in other embodiments, the AP MLD 102 may communicate (e.g., wirelessly communicate) with the STA MLD through more than three communications links or less three than communications links. In some embodiments, the communications links in the multi-link communications system are wireless communications links, which may include one or more 2.4/5/6 GHz links.

In some implementations, a combination of packet number (PN) information for MAC header protection, key identification (ID) information to identify the HPTK (the identifier of the pairwise transient key for MAC header protection), and message integrity check (MIC) information is carried after a MAC header or after a Galois/Counter Mode Protection (GCMP) header to protect the MAC header. The header protection can be used for unicast frames and broadcast frames. However, it may not be clear how to indicate whether the MAC header of a frame is protected. For example, if a MAC header is encrypted, the required time for preparing the responding frame is longer since it is performed after the decryption of the MAC header. A STA that does not support header protection may wrongly assume that a received frame with header protection is intended for it. If the MAC header protection is performed through integrity and replay protection, a STA that does not support MAC header protection may wrongly decode a broadcast frame since it assumes the PN+Key ID+MIC for MAC header protection is part of the frame body or part of the GCMP/Counter Mode with Cipher Block Chaining Message Authentication Code Protocol (CCMP) header.

In some embodiments, MAC header protection is used in a unicast Data frame and the unicast Management frame is transmitted between an AP and an associated STA if the AP and the STA agree to use MAC header protection for the unicast frame between them. In some embodiments, MAC header protection indication is implemented. For example, in a first option, if a Protected Frame field in a frame is equal to 1 and an AP and a STA agree on the MAC header protection, a combination of packet number (PN) information for MAC header protection, key identification (ID) information to identify the HPTK (the identifier of the pairwise transient key for MAC header protection), and message integrity check (MIC) information (PN+Key ID+MIC) in a Header Protection field is carried in the frame. In some embodiments, in a second option, the PHY header of an Ultra High Reliability (UHR) physical layer protocol data unit (PPDU) includes a data field to indicate whether the MAC header protection through a combination of PN information, key ID information, and MIC information (PN+Key ID+MIC) in a Header Protection field is applied to the frame being in the UHR PPDU. In some embodiments, in a third option, a MAC Protocol Data Unit (MPDU) Delimiter that identifies a frame includes a data field to indicate whether the MAC header protection through a combination of PN information, key ID information, and MIC information (PN+Key ID+MIC) in a Header Protection field is applied to the frame being identified by the MPDU Delimiter. In some embodiments, in a fourth option, the Protocol Version field of a frame indicates whether the MAC header protection through a combination of PN information, key ID information, and MIC information (PN+Key ID+MIC) in a Header Protection field is applied to the frame. In some embodiments, in a fifth option, a reserved bit in a MAC header (e.g., one bit in a Traffic Identifier (TID) subfield of a QoS Control field or a Fragment Number subfield in a Sequence Control field) is used to indicate whether an MPDU has a protected MAC header. In some embodiments, in a sixth option, one of the reserved bits in a CCMP/Galois/Counter Mode Protection (GCMP) header is used to indicate whether the MPDU has a protected MAC header. In some embodiments, a Header Protection field with Key ID, PN and MIC is located immediately after the GCMP Header. In some embodiments, the Header Protection field is not encrypted, for example, even if the MAC header protection information is located after a GCMP Header. This option may not be suitable for MAC header protection of a Management frame that is not a robust management frame (e.g., a management frame that is eligible for protection). In some embodiments, not all unicast Management frames have the protected MAC header. In some embodiments, a unicast Probe Response frame has no protected MAC header. In some embodiments, the measurement frames (e.g., sounding feedback related frames, FTM frames, NDP ranging report related frames, etc.) have no protected MAC header. In some embodiments, the measurement frames that are not robust Management frames have no protected MAC header. In some embodiments, the MAC header of a unicast Management frame that has no protected MAC header does not carry the updated critical information (HE Control field, Power Management state change etc.). In some embodiments, the PN space for MAC header protection has its own PN space.

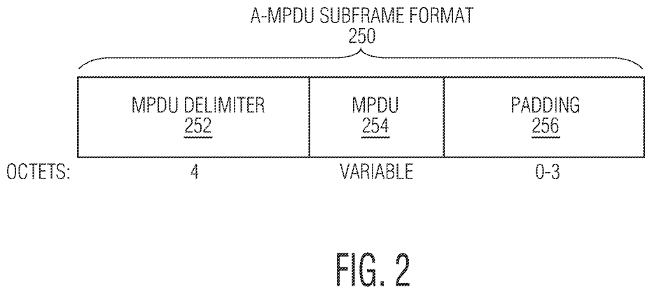

FIG. 2 depicts an example of an Aggregate MAC Protocol Data Unit (A-MPDU) subframe format 250. The A-MPDU subframe format 250 depicted in FIG. 2 may be used by the ML communications system 100 depicted in FIG. 1. In the embodiment depicted in FIG. 2, the A-MPDU subframe format 250 includes a MPDU delimiter 252 (e.g., four-octet) that may contain MPDU delimiter information, an MPDU 254 (e.g., variable length) that may contain MPDU information, and a padding field 256 (e.g., zero-octet to three-octet) that may contain padding information.

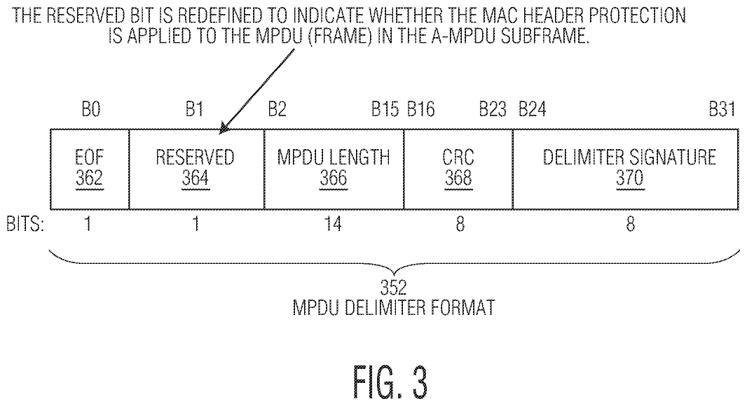

FIG. 3 depicts an MPDU delimiter format 352 in accordance with an embodiment of the invention. The MPDU delimiter format 352 depicted in FIG. 3 is an embodiment of the MPDU delimiter 252 of the A-MPDU subframe format 250 depicted in FIG. 2. However, the MPDU delimiter 252 of the A-MPDU subframe format 250 depicted in FIG. 2 is not limited to the embodiment depicted in FIG. 3. The MPDU delimiter format 352 depicted in FIG. 3 may be used by the ML communications system 100 depicted in FIG. 1. In the embodiment depicted in FIG. 3, the MPDU delimiter format 352 includes an end of frame (EOF) field 362 (e.g., one-bit) that may indicate the A-MPDU subframe being used for padding or the A-MPDU subframe being carrying a frame that solicits Ack frame, a reserved field 364 (e.g., one-bit) that may contain reserved information, an MPDU length field 366 (e.g., fourteen-bit) that may contain MPDU length information, a cyclic redundancy check (CRC) field 368 (e.g., eight-bit) that may contain CRC information, and a delimiter signature field 370 (e.g., eight-bit) that may contain delimiter signature information. In some embodiments, the reserved field 364 is redefined to indicate whether the MAC header protection is applied to the MPDU (frame) in the A-MPDU subframe.

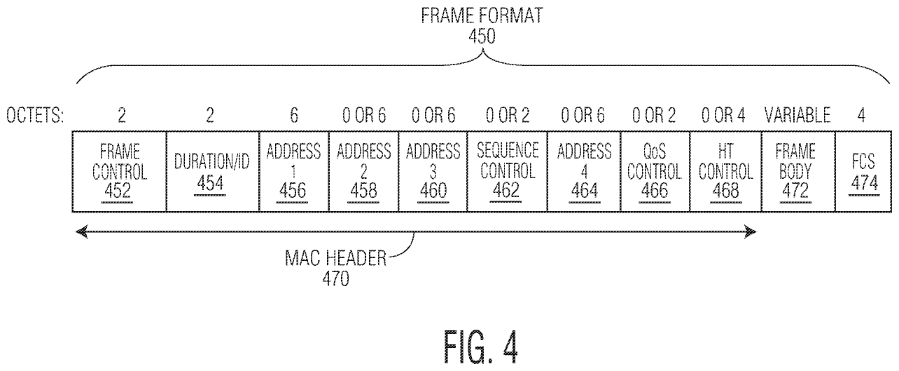

FIG. 4 depicts a frame format 450 in accordance with an embodiment of the invention. The frame format 450 illustrated in FIG. 4 may be used by the ML communications system 100 depicted in FIG. 1. In the embodiment depicted in FIG. 4, the frame format 450 includes a MAC header 470, a frame body 472 (e.g., variable length) that may contain frame body data, and a frame check sequence (FCS) field 474 (e.g., four-octet) that may contain frame check sequence (FCS) information. In the frame format 450 depicted in FIG. 4, the MAC header 470 includes a frame control field 452 (e.g., two-octet) that may contain frame control information, a frame duration/ID field 454 (e.g., two-octet) that may contain frame duration information or ID information, an address field 456 (e.g., six-octet) that may contain address information (e.g., a RA (receiver address or broadcast address) field (e.g., six-octet) that may contain receiver address information), an address field 458 (e.g., zero-octet or six-octet) that may contain address information (e.g., a TA (transmitter address) field (e.g., zero-octet or six-octet) that may contain transmitter address information), an address field 460 (e.g., zero-octet or six-octet) that may contain address information, a sequence control field 462 (e.g., zero-octet or two-octet) that may contain sequence control information, an address field 464 (e.g., zero-octet or six-octet) that may contain address information, a Quality of Service (QoS) control field 466 (e.g., zero-octet or two-octet) that may contain QoS information, and a High Throughput (HT) control field 468 (e.g., zero-octet or four-octet) that may contain HT control information.

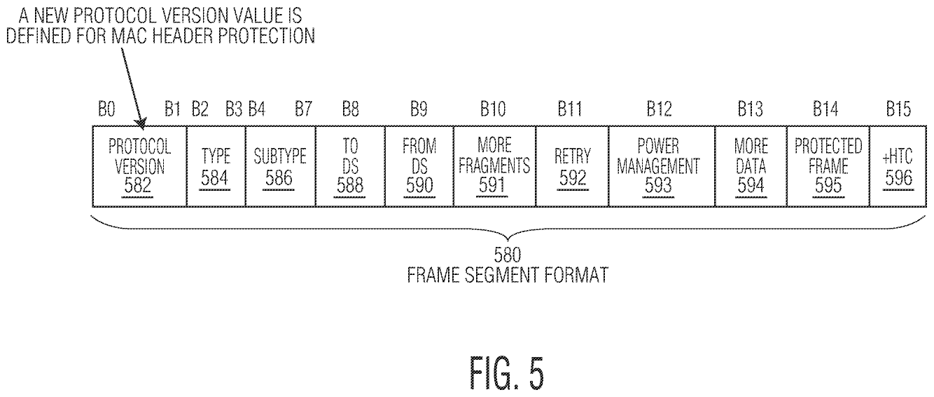

FIG. 5 depicts a frame segment format 580 in accordance with an embodiment of the invention. The frame segment format 580 depicted in FIG. 5 may be used by the ML communications system 100 depicted in FIG. 1. In the embodiment depicted in FIG. 5, the frame segment format 580 includes a protocol version subfield 582 (e.g., two-bit) that may contain protocol version information of the frame, a Type subfield 584 (e.g., two-bit) that may contain Type information of the frame, a Subtype subfield 586 (e.g., two-bit) that may contain Subtype information of the frame, a To DS subfield 588 (e.g., one-bit) that may contain To DS information of the frame, a From DS subfield 590 (e.g., one-bit) that may contain From DS information of the frame, a More Fragments subfield 591 (e.g., one-bit) that may indicate whether the following fragment of a MSDU, a Retry subfield 592 (e.g., one-bit) that may indicate whether the frame is the retransmission, a power management subfield 593 (e.g., one-bit) that may indicate the power management mode being requested, a More Data subfield 594 (e.g., one-bit) that may indicate whether the transmitter of the frame has more buffered frames, a protected frame subfield 595 (e.g., one-bit) that may indicate whether the frame body is protected, and a +HTC (High Throughput (HT) Control) subfield 596 (e.g., one-bit) that may indicate whether the frame carries the HT Control field. In some embodiments, the protocol version subfield 582 (e.g., two-bit) contains a new Protocol Version value that is defined for MAC header protection.

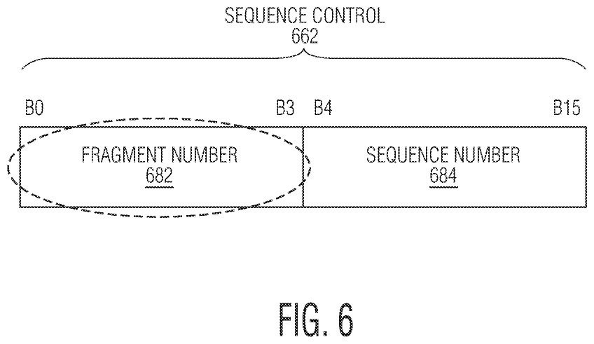

In some embodiments, a reserved bit in a MAC header (e.g., one bit in a Traffic Identifier (TID) subfield of a QoS Control field (e.g., the QoS Control field 466 of the MAC header 470 of the frame format 450 depicted in FIG. 4) or a Fragment Number subfield in a Sequence Control field (e.g., the Sequence Control field 462 of the MAC header 470 of the frame format 450 depicted in FIG. 4) is used to indicate whether an MPDU has a protected MAC header. FIG. 6 depicts a sequence control field format 662 in accordance with an embodiment of the invention. The Sequence Control field format 662 depicted in FIG. 6 may be an embodiment of the Sequence Control field 462 of the MAC header 470 of the frame format 450 depicted in FIG. 4. In the embodiment depicted in FIG. 6, the Sequence Control field format 662 includes a fragment number subfield 682 (e.g., four-bit) that may contain fragment number information and a sequence number subfield 684 (e.g., twelve-bit) that may contain sequence number information. In some embodiments, the Fragment Number subfield 682 is used to indicate whether an MPDU has a protected MAC header.

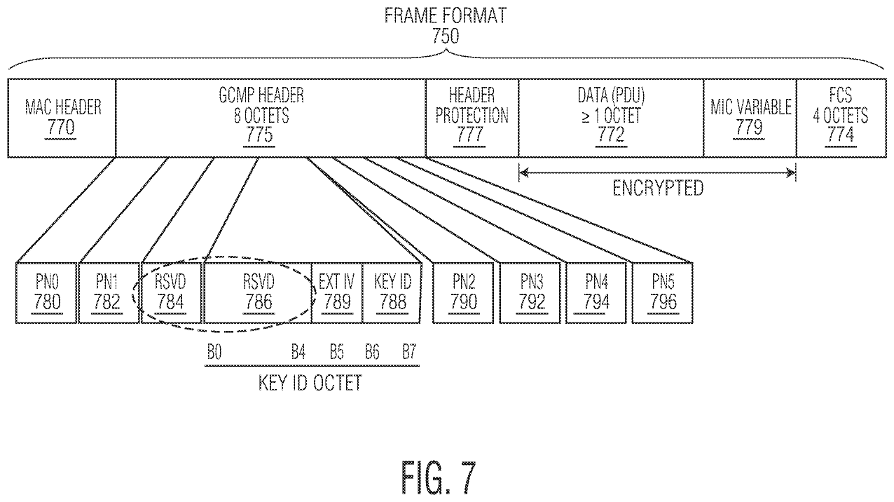

In some embodiments, one of the reserved bits in a CCMP/GCMP header is used to indicate whether an MPDU has a protected MAC header. FIG. 7 depicts a frame format 750 in accordance with an embodiment of the invention. The frame format 750 depicted in FIG. 7 may be used by the ML communications system 100 depicted in FIG. 1. In the embodiment depicted in FIG. 7, the frame format 750 includes a MAC header 770, a GCMP header 775 (e.g., eight-octet), a header protection field 777 that may contain header protection information, a data field 772 (e.g., one-octet or more than one-octet) that may contain payload data, a MIC field 779 (e.g., variable length) that may contain MIC information, and an FCS field (e.g., four-octet) that may contain FCS information. The GCMP header 775 may include packet number fields PN0, PN1, PN2, PN3, PN4, PN5 780, 782, 790, 792, 794, 796, a reserved (Rsvd) field 784 that may contain reserved information, a reserved (Rsvd) field 786 that may contain reserved information, a key ID field 778 that may identify the key being used for encrypt/decrypt the frame body, and an extension field 789 that may contain extension information. In some embodiments, the reserved (Rsvd) field 784 and/or the reserved (Rsvd) field 786 is used to indicate whether the frame format 750 has a protected MAC header 770. In some embodiments, the reserved (Rsvd) field 786, the extension field 789, and the key ID field 788 contain one octet of data. In some embodiments, the Header Protection field 777 with Key ID, PN and MIC is immediately after the GCMP Header 775. In some embodiments, the Header Protection field is not encrypted. In some embodiments, this option may not be suitable for MAC header protection of a Management frame that is not a robust management frame (a management frame that is eligible for protection).

In some embodiments, not all unicast management frames between an AP and a STA that agree to use MAC header protection are unicast Data frames or unicast Management frames between the AP and the STA. In some implementations of wireless communications (e.g., according to an IEEE 802.11 protocol, based on active scanning rules, a unicast Probe Response frame may be decoded by a third-party STA. Applying MAC header protection to a unicast Probe Request may confuse a third-party STA. Accordingly, in some embodiments, besides the unicast Data frames between an AP and a STA that agree the MAC header protection, the MAC header protection is applied to the unicast Management frames other than the unicast Probe Request between the AP and the STA that agree the MAC header protection. In some embodiments, besides the unicast Data frames between an AP and a STA that agree the MAC header protection, the MAC header protection is applied to the robust unicast Management frames between the AP and the STA that agree the MAC header protection. In some embodiments, besides the unicast Data frames between an AP and a STA that agree the MAC header protection, the MAC header protection is applied to the class 3 unicast Management frames between the AP and the STA that agree the MAC header protection. In some embodiments, besides the unicast Data frames between an AP and a STA that agree the MAC header protection, the MAC header protection is applied to the unicast Management frames other than the measurement frames between the AP and the STA that agree the MAC header protection. In some embodiments, the measurement frames include sounding related management frames for the sounding feedback, the FTM frame, the measurement feedback related to NDP ranging, the measurement feedback related to sensing. In some embodiments, the unicast Management frames without header protection between an AP and a STA that agree MAC header protection do not carry the critical information in its MAC header.

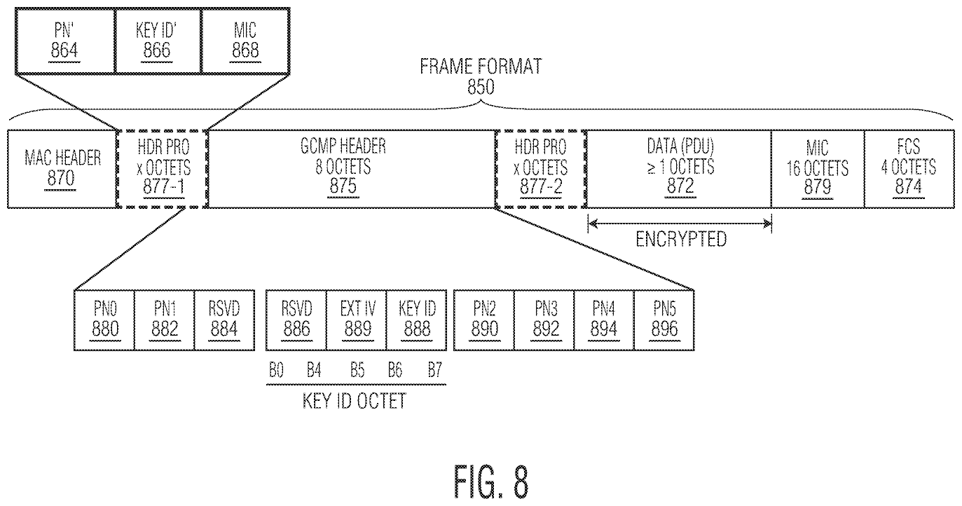

In some embodiments, a Protected Management Frame with MAC Header Protection is implemented. For example, in a first option, a header protection (HDR PRO) field that carries Key ID, PN and MIC is located before a GCMP header or after a GCMP header. In some embodiments, the MAC header protection for broadcast (group-addressed) Management frame and data frame is not allowed, i.e., the MAC header protection is only applied to a unicast Management frames and unicast Data frame. FIG. 8 depicts a frame format 850 in accordance with an embodiment of the invention. The frame format 850 depicted in FIG. 8 may be used by the ML communications system 100 depicted in FIG. 1. In some embodiments, the frame format 850 depicted in FIG. 8 is a unicast data or Management frame. In the embodiment depicted in FIG. 8, the frame format 850 includes a MAC header 870, an optional HDR PRO field 877-1 that may contain header protection information, a GCMP header 875 (e.g., eight-octet), an optional HDR PRO field 877-2 that may contain header protection information (Key ID, PN, MIC) for MAC header protection, a data field 872 (e.g., one-octet or more than one-octet) that may contain payload data, a MIC field 879 (e.g., sixteen-octet) that may contain MIC information for the frame body protection, and an FCS field (e.g., four-octet) that may contain FCS information. The GCMP header 875 may include packet number fields PN0, PN1, PN2, PN3, PN4, PN5 880, 882, 890, 892, 894, 896 for frame body protection, a reserved (Rsvd) field 884 that may contain reserved information, a reserved (Rsvd) field 886 that may contain reserved information, a key ID field 878 that may contain key identification information for frame body protection, and an extension field 889 that may contain extension information. In some embodiments, the reserved (Rsvd) field 886, the extension field 889, and the key ID field 888 contain one octet of data. In the embodiment depicted in FIG. 8, the HDR PRO field 877-1 is located before the GCMP header while the HDR PRO field 877-2 is located after the GCMP header. In some embodiments, the HDR PRO field 877-1 or 877-2 includes a PN field 864 for MAC header protection that may contain PN information, a Key ID field 866 for MAC header protection that may contain Key ID information, and a MIC field 868 for MAC header protection that may contain MIC information. In some embodiments, the Key ID field 866, the PN field 864 and the MIC field 868 have different values from the Key ID field 888, PN identified by PN0 to PN5, the MIC field 879. In some embodiments, the Key ID field 866 and the Key ID field 888 have the same value. In some embodiments, the Key ID field 866 is not required where the Key ID field 888 identifies the Key for MAC header protection. In such embodiments, the PTK (pairwise transient key) for MAC header protection and the PTK for frame body protection of the unicast frames are updated at the same time.

In some embodiments, in a first variant, the MAC header of the unicast Data/Management frame between an AP and a STA in State 4 that agree to protect MAC header of the unicast Data and unicast Management frame has the following exception: the MAC header of the unicast Probe Response is not protected. In some embodiments, the unprotected MAC header of the unicast Data/Management frame between a peer AP and a STA in State 4 that agree to protect MAC header does not carry the critical information change (e.g., power management mode change, more data indication in More Data field, changes carried in HT Control). The recipient that agrees to the MAC header protection with the transmitter may ignore the critical information in MAC header of a unicast frame without MAC header protection.

In some embodiments, in a second variant, the MAC header of the unicast Data/Management frame between an AP and a STA in State 4 that agree to protect MAC header of the unicast Data and unicast Management frame has the following exceptions: 1) the MAC header of the unicast Probe Response is not protected, 2), the MAC header of unicast frame for measurement that may be a frame for sounding report (Channel state information (CSI) frame, a Compressed/Uncompressed Beamforming frame, a Very High Throughput (VHT) Compressed Beamforming frame, a High Efficiency (HE)/Extremely High Throughput (EHT)/Ultra High Reliability (UHR) (HE/EHT/UHR) Compressed Beamforming/channel quality indicator (CQI) frame, LMR (Location Measurement Report), a Fine Timing Measurement (FTM) frame, or a Fine Measurement frame. In some embodiments, the unprotected MAC header of the unicast Data/Management frame between a peer AP and a STA in State 4 that agree to protect MAC header does not carry the critical information change (e.g., power management mode change, more data indication in More Data field, changes carried in HT Control). The recipient that agrees to the MAC header protection with the transmitter may ignore the critical information in MAC header of a unicast frame without MAC header protection.

In some embodiments, in a third variant, the MAC header of the unicast Data/Management frame between a peer AP and a STA in State 4 that agree to protect MAC header of the unicast Data and unicast Management frame has the following exception: the MAC header of a unicast Management frame that is not class 3 frame is not protected. In some embodiments, the unprotected MAC header of the unicast Data/Management frame between a peer AP and a STA in State 4 that agree to protect MAC header does not carry the critical information change (e.g., power management mode change, more data indication in More Data field, changes carried in HT Control). The recipient that agrees to the MAC header protection with the transmitter may ignore the critical information in MAC header of a unicast frame without MAC header protection.

In some embodiments, in a fourth variant, the MAC header of the unicast Data/Management frame between a peer AP and a STA in State 4 that agree to protect MAC header of the unicast Data and unicast Management frame has the following exception: the MAC header of a unicast Management frame that is not robust Management frame is not protected. In some embodiments, the unprotected MAC header of the unicast Data/Management frame between a peer AP and a STA in State 4 that agree to protect MAC header does not carry the critical information change (e.g., power management mode change, more data indication in More Data field, changes carried in HT Control). The recipient that agrees to the MAC header protection with the transmitter may ignore the critical information in MAC header of a unicast frame without MAC header protection.

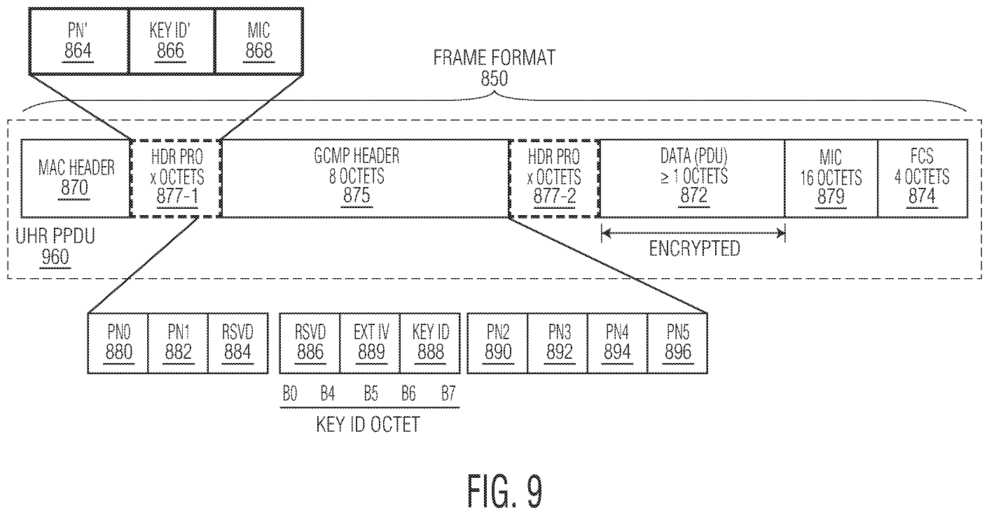

In some embodiments, a protected management frame with MAC header protection is implemented in a second option in which an HDR PRO field is located before a GCMP header or after a GCMP header. With this arrangement, a 3rd-party non-UHR STA may wrongly decode the management frame with an HDR PRO field (treating HDR PRO field as the other field). To address this issue, the broadcast management frame with an HDR PRO field can be carried in a UHR PPDU. FIG. 9 depicts a UHR PPDU 960 in accordance with an embodiment of the invention. The UHR PPDU 960 depicted in FIG. 9 may be used by the ML communications system 100 depicted in FIG. 1. In the embodiment depicted in FIG. 9, the UHR PPDU 960 carries or includes the frame format 850 depicted in FIG. 8. In some embodiments, an UHR STA that does not support the MAC header protection can skip the HDR PRO field 877-1 or 877-2 or only receive the management frame without the HDR PRO field. A non-UHR STA will not be able to decode the PPDU. In some embodiments, the broadcast Management frame needs to be transmitted two times: one without an HDR PRO field in a PPDU that is not a UHR PPDU for STAs that do not support MAC header protection, another in a UHR PPDU with an HDR PRO field for STAs that support MAC header protection. A STA that supports MAC header protection processes the broadcast Management frame with an HDR PRO field and ignores the broadcast Management frame without an HDR PRO field.

In some embodiments, a protected management frame with MAC header protection is implemented in a third option in which a PN+Key ID+MIC in a Header Protection field is carried in a new element, e.g., a Header MIC Information element (HME) format. In some embodiments, the HME is located right before a Management MIC element (MME) in a protected management frame with MAC header protection. The other location before MME is also possible. In some embodiments, the HME is located after the MME. In some embodiments, such arrangement is applied to a broadcast management frame.

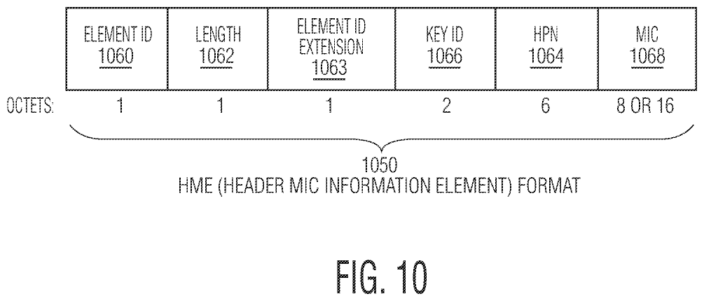

FIG. 10 depicts an HME format 1050 in accordance with an embodiment of the invention. The HME format 1050 depicted in FIG. 10 may be used by the ML communications system 100 depicted in FIG. 1. In the embodiment depicted in FIG. 10, the HME format 1050 includes an element ID subfield 1060 (e.g., one-octet) that may contain element ID information, a length subfield 1062 (e.g., one-octet) that may contain element length information, an element ID extension subfield 1063 (e.g., one-octet) that may contain element ID extension information, an HPN subfield 1064 (e.g., six-octet) that may contain HPN (PN for header protection) information, a Key ID subfield 1066 (e.g., two-octet) that may contain Key ID information, and a MIC subfield 1068 (e.g., eight-octet or sixteen-octet) that may contain MIC information.

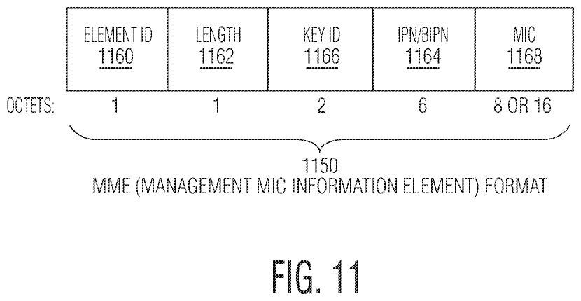

FIG. 11 depicts an MME format 1150 in accordance with an embodiment of the invention. The MME format 1150 depicted in FIG. 11 may be used by the ML communications system 100 depicted in FIG. 1. In the embodiment depicted in FIG. 11, the MME format 1150 includes an element ID subfield 1160 (e.g., one-octet) that may contain element ID information, a length subfield 1162 (e.g., one-octet) that may contain element length information, an Integrity Packet Number (IPN)/Beacon Integrity Packet Number (BIPN) (IPN/BIPN) subfield 1164 (e.g., two-octet) that may contain IPN/BIPN information, a Key ID subfield 1166 (e.g., two-octet) that may contain Key ID information, and a MIC subfield 1168 (e.g., eight-octet or sixteen-octet) that may contain MIC information.

In some embodiments, a protected data frame with MAC header protection is implemented. For example, in a first option, an HDR PRO field is located before a GCMP header or after a GCMP header. In some embodiments, MAC header protection for a broadcast (group-addressed) data frame is not allowed, i.e., the MAC header protection is only applied to a unicast Data frame.

In some embodiments, protected data frame with MAC header protection is implemented in a second option in which an HDR PRO field is located before a GCMP header or after a GCMP header. With this arrangement, a 3^{nd}-party non-UHR STA may wrongly decode a broadcast data frame with HDR PRO field. To address this issue, the broadcast data frame with an HDR PRO field can be carried in a UHR PPDU (e.g., the UHR PPDU 960 depicted in FIG. 9). In some embodiments, a STA that does not support the MAC header protection can skip an HDR PRO field or only receive the broadcast data frame without an HDR PRO field. In some embodiments, the broadcast data frame needs to be transmitted two times: one without an HDR PRO field in a non-UHR PPDU for STAs that do not support MAC header protection, another one with an HDR PRO field in a UHR PPDU for STAs that support MAC header protection. In some embodiments, a STA that supports MAC header protection processes the broadcast data frame with an HDR PRO field in a UHR PPDU and ignores the broadcast data frame without an HDR PRO field in a non-UHR PPDU.

Header-protection pairwise transient key (HPTK) and header-protection group transient key (HGTK) under multi-link operation (MLO) may be used. In some embodiments, HPTK (header-protection pairwise transient key) is implemented. In some embodiments, in a first option, per link HPTK is implemented. For example, an AP MLD and an associated non-AP MLD negotiates HPTK for each setup link. In some embodiments, separate PN spaces are used for different setup links. In some embodiments, in a second option, per MLD HPTK is implemented. For example, an AP MLD and an associated non-AP MLD negotiate HPTK for MLD level. In some embodiments, separate PN spaces are used for different setup links. The different link addresses of the AP/non-AP MLD in the frame identified by A2 (transmitter address) may be used in different links for Nonce configuration. In some embodiments, the same PN space is used for the setup links. For example, if one PN is used in one link, the PN value cannot be used in another link. In some embodiments, in a third option, per link HPTK is implemented. For example, an AP MLD notifies a non-AP MLD the HPTK for each setup link between the AP MLD and the non-AP MLD. In some embodiments, separate PN spaces are used for different setup links. In some embodiments, in a fourth option, per MLD HPTK is implemented. For example, an AP MLD notifies a non-AP MLD the HPTK for the non-AP MLD between the AP MLD and the non-AP MLD. In some embodiments, separate PN spaces are used for different setup links. The different link addresses of the AP/non-AP MLD in the frame identified by A2 (transmitter address) may be used in different links for Nonce configuration In some embodiments, the same PN space is used for the setup links. For example, if one PN is used in one link, the PN value cannot be used in another link. In some embodiments, HGTK (header-protection group transient key) is implemented. In some embodiments, in a first option, per link HGTK is implemented. For example, an AP MLD announces the HGTK for each its link to the non-AP MLDs. In some embodiments, separate PN spaces are used for different setup links. In some embodiments, in a second option, per MLD HPTK is implemented. For example, an AP MLD announces the MLD level HGTK to the non-AP MLDs. In some embodiments, separate PN spaces are used for different setup links. The different link addresses of the AP/non-AP MLD in the frame identified by A2 (transmitter address) may be used in different links for Nonce configuration. In some embodiments, the same PN space is used for the links. For example, if one PN is used in one link, the PN value cannot be used in another link.

In some embodiments, unified HPTK and CPTK is implemented. In some embodiments, the PTK for MAC header protection (HPTK) and the PTK for Control frame protection (CPTK) between an AP MLD and an associated non-AP MLD with the AP MLD are the same.

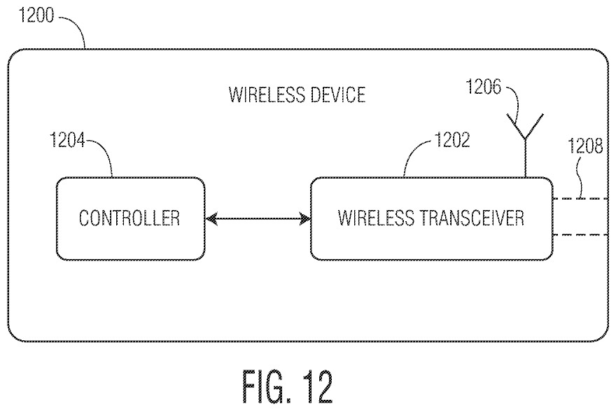

FIG. 12 depicts a wireless device 1200 in accordance with an embodiment of the invention. The wireless device 1200 can be used in the multi-link communications system 100 depicted in FIG. 1. For example, the wireless device 1200 may be an embodiment of the APs 110-1, 110-2, 110-3 or the STAs 120-1, 120-2, 120-3 depicted in FIG. 1. However, the APs 110-1, 110-2, 110-3 or the STAs 120-1, 120-2, 120-3 depicted in FIG. 1 are not limited to the embodiment depicted in FIG. 12. In the embodiment depicted in FIG. 12, the wireless device 1200 includes a wireless transceiver 1202, a controller 1204 operably connected to the wireless transceiver, and at least one antenna 1206 operably connected to the wireless transceiver. In some embodiments, the wireless device 1200 may include at least one optional network port 1208 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol (e.g., an IEEE 802.11bn protocol)). In some embodiments, the wireless device 1200 includes multiple transceivers. The controller may be configured to control the wireless transceiver to process packets received through the antenna and/or the network port and/or to generate outgoing packets to be transmitted through the antenna and/or the network port. In some embodiments, the controller is implemented within a processor, such as a microcontroller, a host processor, a host, a DSP, or a CPU. The antenna may be any suitable type of antenna. For example, the antenna may be an induction type antenna such as a loop antenna or any other suitable type of induction type antenna. However, the antenna is not limited to an induction type antenna. The network port may be any suitable type of port. The wireless device 1200 may be compatible with an IEEE 802.11 protocol (e.g., an IEEE 802.11 bn protocol).

In accordance with an embodiment of the invention, the controller 1204 is configured to generate a frame including a Media Access Control (MAC) header and a security encapsulation for MAC header protection, where the security encapsulation includes packet number (PN) information, key identification (ID) information, and message integrity check (MIC) information, and the wireless transceiver 1202 is configured to transmit the frame to a second communications device. In some embodiments, the frame is one of a unicast data frame and a unicast management frame. In some embodiments, the wireless device 1200 includes a wireless multi-link device (MLD), the second communications device includes a second wireless MLD, and the wireless transceiver is further configured to transmit the frame to the second wireless MLD through a wireless link between the wireless MLD and the second wireless MLD. In some embodiments, the controller is further configured to generate the frame including the MAC header, the security encapsulation for MAC header protection, a frame body, and a frame check sequence (FCS) field. In some embodiments, the data field is included in a physical layer (PHY) header of the frame. In some embodiments, the data field is included in a MAC Protocol Data Unit (MPDU) delimiter of the frame (e.g., the frame is included in an Aggregate MAC Protocol Data Unit (A-MPDU) subframe with a MAC Protocol Data Unit (MPDU) delimiter). In some embodiments, the MPDU Delimiter indicates whether the frame has security encapsulation for header protection or not. In some embodiments, the data field is included in a protocol version field of the frame. In some embodiments, the security encapsulation is located after a Galois/Counter Mode Protection (GCMP) header of the frame. In some embodiments, the security encapsulation is located right after the MAC header (e.g., no information between the security encapsulation and the MAC header). In some embodiments, the data field includes a reserved data field of a Cipher Block Chaining Message Authentication Code Protocol (CCMP) header or a Galois/Counter Mode Protection (GCMP) header of the frame. In some embodiments, a transmitter address (TA) of the frame is used to configure a Nonce for calculating the MIC information. In some embodiments, the MAC header includes a reserved data field for indicating that the security encapsulation is carried in the frame (e.g., a redefined reserved bit for indicating that the security encapsulation is carried in the frame). In some embodiments, the frame includes a multicast or broadcast frame that is carried in an Ultra High Reliability (UHR) physical layer protocol data unit (PPDU). In some embodiments, the security encapsulation is located before or after a Galois/Counter Mode Protection (GCMP) header of the frame if the GCMP header exists, otherwise, security encapsulation is located after the MAC header. In some embodiments, a header-protection pairwise transient key (HPTK) is negotiated for all setup links between the communications device and the second communications device. In some embodiments, separate PN spaces are used for different setup links between the communications device and the second communications device. In some embodiments, the HPTK is used as the pairwise transient key for controlling frame protection. In some embodiments, the wireless device 1200 is compatible with an Institute of Electrical and Electronics Engineers (IEEE) 802.11 protocol. In some embodiments, the wireless device 1200 includes a wireless access point (AP) or a non-AP station (STA).

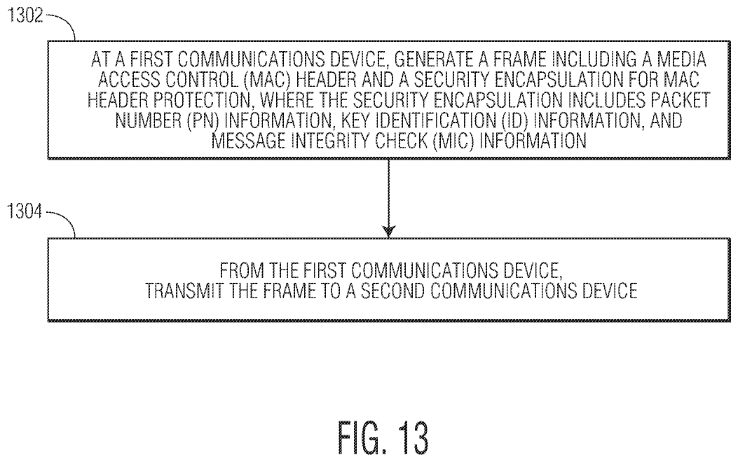

FIG. 13 is a process flow diagram of a method for communications in accordance with an embodiment of the invention. At block 1302, at a first communications device, a frame including a Media Access Control (MAC) header and a security encapsulation for MAC header protection is generated, where the security encapsulation includes packet number (PN) information, key identification (ID) information, and message integrity check (MIC) information. At block 1304, from the first communications device, the frame is transmitted to a second communications device. In some embodiments, the frame is one of a unicast data frame and a unicast management frame. In some embodiments, the first communications device includes a wireless multi-link device (MLD), the second communications device includes a second wireless MLD, and the frame is transmitted to the second wireless MLD through a wireless link between the wireless MLD and the second wireless MLD. In some embodiments, the frame includes the MAC header, the security encapsulation for MAC header protection, a frame body, and a frame check sequence (FCS) field. In some embodiments, the frame is included in an Aggregate MAC Protocol Data Unit (A-MPDU) subframe with a MAC Protocol Data Unit (MPDU) delimiter. In some embodiments, the MPDU Delimiter indicates whether the frame has security encapsulation for header protection or not. In some embodiments, the MAC header includes a redefined reserved data bit for indicating that the security encapsulation is carried in the frame. In some embodiments, the security encapsulation is located before or after a Galois/Counter Mode Protection (GCMP) header of the frame if the GCMP header exists, otherwise the security encapsulation is located right after the MAC header. In some embodiments, a header-protection pairwise transient key (HPTK) is negotiated between the communications device and the second communications device. In some embodiments, separate PN spaces are used for different setup links between the communications device and the second communications device. In some embodiments, the first communications device and/or the second communications device is compatible with an Institute of Electrical and Electronics Engineers (IEEE) 802.11 protocol. In some embodiments, the communications device includes a wireless access point (AP) or a non-AP station (STA). The first communications device and/or the second communications device may be the same as, similar to, a component of, or include the AP MLD 102 depicted in FIG. 1 the non-AP MLD 104-1, 104-2, or 104-3 depicted in FIG. 1, the APs 110-1, 110-2, 110-3, the STAs 120-1, 120-2, 120-3 depicted in FIG. 1, and/or the wireless device 1200 depicted in FIG. 12.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A communications device comprising:
a controller configured to generate a frame including a Media Access Control (MAC) header and a security encapsulation for MAC header protection, wherein the security encapsulation comprises packet number (PN) information, key identification (ID) information, and message integrity check (MIC) information; and
a transceiver configured to transmit the frame to a second communications device.

2. The communications device of claim 1, wherein the frame is one of a unicast data frame and a unicast management frame.

3. The communications device of claim 2, wherein the communications device comprises a wireless multi-link device (MLD), wherein the second communications device comprises a second wireless MLD, and wherein the transceiver comprises a wireless transceiver configured to transmit the frame to the second wireless MLD through a wireless link between the wireless MLD and the second wireless MLD.

4. The communications device of claim 2, wherein the controller is further configured to generate the frame including the MAC header, the security encapsulation for MAC header protection, a frame body, and a frame check sequence (FCS) field.

5. The communications device of claim 4, wherein the frame is included in an Aggregate MAC Protocol Data Unit (A-MPDU) subframe with a MAC Protocol Data Unit (MPDU) delimiter.

6. The communications device of claim 5, wherein the MPDU delimiter indicates whether the frame has security encapsulation for header protection or not.

7. The communications device of claim 4, wherein the security encapsulation is located after a Galois/Counter Mode Protection (GCMP) header of the frame.

8. The communications device of claim 4, wherein the security encapsulation is located right after the MAC header.

9. The communications device of claim 4, wherein a transmitter address (TA) of the frame is used to configure a Nonce for calculating the MIC information.

10. The communications device of claim 2, wherein the MAC header comprises a redefined reserved bit for indicating that the security encapsulation is carried in the frame.

11. The communications device of claim 1, wherein a header-protection transient pairwise key (HTPK) is negotiated for all setup links between the communications device and the second communications device.

12. The communications device of claim 11, wherein separate PN spaces are used for different setup links between the communications device and the second communications device.

13. The communications device of claim 11, wherein the HPTK is used as the pairwise transient key for controlling frame protection.

14. A wireless multi-link device (MLD) comprising:
a controller configured to generate a frame including a Media Access Control (MAC) header and a security encapsulation for MAC header protection, wherein the security encapsulation comprises packet number (PN) information, key identification (ID) information, and message integrity check (MIC) information; and
a wireless transceiver configured to transmit the frame to a second wireless MLD through a wireless link between the wireless MLD and the second wireless MLD, wherein the wireless MLD and the second wireless MLD are compatible with an Institute of Electrical and Electronics Engineers (IEEE) 802.11 protocol.

15. The wireless MLD of claim 14, wherein the wireless MLD comprises a wireless access point (AP) MLD or a non-AP station (STA) MLD.

16. A method for communications, the method comprising:
at a first communications device, generating a frame including a Media Access Control (MAC) header and a security encapsulation for MAC header protection, wherein the security encapsulation comprises packet number (PN) information, key identification (ID) information, and message integrity check (MIC) information; and
from the first communications device, transmitting the frame to a second communications device.

17. The method of claim 16, wherein the frame is one of a unicast data frame and a unicast management frame.

18. The method of claim 16, wherein the first communications device comprises a first wireless multi-link device (MLD), and wherein the second communications device comprises a second wireless MLD.

19. The method of claim 16, wherein the security encapsulation is located after a Galois/Counter Mode Protection (GCMP) header of the frame.

20. The method of claim 16, wherein the first communications device or the second communications device is compatible with an Institute of Electrical and Electronics Engineers (IEEE) 802.11 protocol.
